(19) United States
(12) Patent Application Publication
(10) Pub. No.: US 2026/0205201 A1
(43) Pub. Date: Jul. 16, 2026

(54) Metal Embedded RF Photonic Assembly For Compact Millimeter Wave Emitter Array

(71) Applicant: HRL Laboratories, LLC, Malibu, CA (US)

(72) Inventors: John CARLSON, Malibu, CA (US); Avantika Sodhi, Malibu, CA (US); Christina M. Seeholzer, Malibu, CA (US); Amirfarshad Mashal, Malibu, CA (US)

(73) Assignee: HRL Laboratories, LLC, Malibu, CA (US)

(21) Appl. No.: 19/022,951

(22) Filed: Jan. 15, 2025

(51) Int. Cl. H04B 10/50; G02B 6/42; H01Q 1/24; H01Q 21/06; H04B 10/25; H04B 10/40

(52) U.S. Cl. CPC H04B 10/503; G02B 6/4201; H01Q 1/24; H01Q 21/065; H04B 10/25; H04B 10/40; H04B 2210/006

(57) ABSTRACT

An optoelectronic emitter including a light detection wafer having first top and bottom surfaces, the light detection wafer comprising at least one photodetector chip arranged to receive light in an optical input on the first bottom surface, along a photodetector axis normal to the first bottom surface and to output an electrical signal from at least one signal output pad on the first top surface; and an antenna wafer having a second bottom surface attached to the first top surface and having a second top surface, at least one antenna patch being arranged on the second top surface and being connected by a via to a bottom antenna pad on the second bottom surface, the bottom antenna pad being electrically coupled to the at least one signal output pad on the first top surface.

### RELATED APPLICATIONS

This application relates to U.S. Pat. No. 10,998,273; which is hereby incorporated by reference.

### TECHNICAL FIELD

This presentation relates to opto-electronic assemblies provided for transforming a radio signal into an optical signal or for transforming an optical signal into a radio signal; in particular compact opto-electronic assemblies comprising a plurality of layers, each layer comprising different electrical or opto-electrical components coupled to the components of the other layers.

### BACKGROUND

RF transceivers comprise at least an antenna coupled to electronic circuits that process signals to or from the antenna. The electronic circuits are preferably arranged close together to reduce RF signal loss. However, arranging the electronic circuits close together create heating problems. The signal loss and heating problems are particularly important in complex structures such as RF phased arrays, that comprise a dense array of antennas as well as electronic circuits provided for receiving and processing RF signals received on the array of antennas or for generating RF signals and emitting them with the array of antennas. The electronic circuits of RF phased arrays can include power amplifiers, a beamformer circuit, ADC circuitry, logic, and memory. It is known to alleviate thermal issues and/or signal loss by transforming some of the RF signals into optical signals, since optical signals allow reducing the proximity of the circuits while limiting losses. However, the size of the laser sources needed to generate the optical signals or of the photodetectors needed to transform received optical signals into RF signals have until now prevented very dense integration of the electronics transforming the RF signals into optical signals or transforming optical signals into RF signals.

U.S. Pat. No. 12,072,623, which is hereby incorporated by reference in its entirety and is entitled: “Two-dimensional conformal optically-fed phased array and methods of manufacturing the same” , discloses two-dimensional conformal optically-fed phased arrays and methods for manufacturing the same. The method includes providing a wafer substrate, depositing a first cladding layer on the wafer substrate, and depositing a core layer on the first cladding layer. The method further includes photolithographically patterning the core layer to provide a plurality of optical waveguide cores, and depositing a second cladding layer on the core layer to cover the plurality of optical waveguide cores to provide a plurality of optical waveguides. In addition, the method includes forming a plurality of antennas on the second cladding layer, each antenna of the plurality of antennas located near a termination of a corresponding optical waveguide of the plurality of optical waveguides, and providing a plurality of photodiodes on the second cladding layer, each photodiode of the plurality of photodiodes connected to a corresponding

antenna.

U.S. Pat. No. 4,965,603, which is hereby incorporated by reference in its entirety and is entitled: “Optical beamforming network for controlling an RF phased array” , discloses an optical beamforming network that is provided for controlling the RF radiation pattern of a phased array antenna. Light from a first laser is modulated by a spatial light modulator that is user-programmed with the desired far field radiation footprint. The modulated light beam is directed through a Fourier transform lens and onto a beam splitter where it is combined with light from a second laser that is frequency offset by the RF center frequency of the antenna. Light from the beam splitter is recovered by first and second fiber optic bundles. Each optical fiber leads to a corresponding photodetector that detects the beat frequency produced by the two frequency offset light beams. The outputs of corresponding photodetectors of the two fiber optic bundles are combined to control the radiation of a corresponding radiation element of the phased array. The use of two sets of optical fibers and photodetectors improves the signal-to-noise ratio of the system. An alternative embodiment uses photorefractive crystals to pass phase conjugate return beams back through the optical lenses to cancel lens-induced aberrations from the spatially modulated light beam. This embodiment reduces distortion of the far field radiation pattern without the use of high quality optical lenses.

U.S. Pat. No. 4,258,363, which is hereby incorporated by reference in its entirety and is entitled: “Phased array radar” , discloses phased array radar system where the radiating elements of the antenna are connected to associated RF transmitter-receiver modules. Each of the modules receives a transmitter signal and a local oscillator signal and delivers, upon reception of an echo signal via the antenna an IF signal. Furthermore a system of fiber optical waveguides is incorporated to distribute to the modules the transmitter signal and the local oscillator signal, both of which signals being modulated on carriers, which are frequency-matched to the system of fiber optical waveguides. Each of the modules comprises a demodulator to procure the transmitter signal and the local oscillator signal from the applied modulated signals.

U.S. Pat. No. 4,885,589, which is hereby incorporated by reference in its entirety and is entitled: “Optical distribution of transmitter signals and antenna returns in a phased array radar system” , discloses a distribution of radio frequency signals using optical fibers between a centrally located radar transmitter/receiver and remotely located transmit/receive modules associated with the elements of an active phased array. The system avoids the need for remotely located lasers, by using the optical carrier generated at the central location for both transmission, when it is modulated by the transmitter and supplied to each T/R module over an optical path; and for reception, when it is supplied to each T/R module unmodulated. An optical switch and an optical modulator in the T/R module permit the antenna return to be converted to an optical format for supply over a second optical path to the central receiver. The arrangement may be further simplified by selecting a simple optical device to perform both the optical switching and optical modulation function in each T/R module.

U.S. Pat. No. 7,898,464, which is hereby incorporated by reference in its entirety and is entitled: “System and method for transmitting signals via photonic excitation of a transmitter array” , discloses a radio frequency (RF) phased array transmitter system that comprises a phased array for generating an RF signal. The phased array comprises conductive patches formed in an array, separation gaps, and active sources. Each of the separation gaps is formed between two adjacent ones of the conductive patches, and each of the active sources is formed across its associated one of the separation gaps. The system further comprises an optical source for generating an optical signal and an RF source for generating an RF signal. In addition, the system comprises an optical modulator coupled to the optical source and the RF source. The optical modulator receives an optical signal and an RF signal, and produces an RF modulated optical signal based on the received optical signal and the received RF signal.

There remains a need for a RF phased array that has a compact size and nevertheless addresses both the signal loss and thermal bottlenecking that otherwise would derive from the compact size.

### SUMMARY

Embodiments of the presentation comprise a RF phased array where RF electronic and photonic/optoelectronic components are stacked vertically and where thermal bottlenecking is reduced by encasing the highest-power devices in a plated metal sink.

Embodiments of this presentation include an optoelectronic emitter comprising: a light detection wafer having first top and bottom surfaces, the light detection wafer comprising at least one photodetector chip arranged to receive light in an optical input on the first bottom surface, along a photodetector axis normal to the first bottom surface and to output an electrical signal from at least one signal output pad on the first top surface; and an antenna wafer having a second bottom surface attached to the first top surface and having a second top surface, at least one antenna patch being arranged on the second top surface and being connected by a via to a bottom antenna pad on the second bottom surface, the bottom antenna pad being electrically coupled to the at least one signal output pad on the first top surface.

According to embodiments of this presentation, the optoelectronic emitter comprises an optical waveguide wafer having a third top surface attached to the first bottom surface and having a third bottom surface; the optical waveguide wafer comprising at least one optical waveguide having a waveguide output on the third top surface and a waveguide input on the third bottom surface, the waveguide output being aligned with the photodetector axis; and a fiber optic connector arranged to receive an end of a fiber optic being attached to the third bottom surface such that light output from said fiber optic enters the optical waveguide by the waveguide input.

According to embodiments of this presentation, the third top surface is attached to the first bottom surface by an attachment layer comprising at least one optical lens arranged to focus light output from the waveguide output on the third top surface into the optical input on the first bottom surface.

According to embodiments of this presentation, the second bottom surface is attached to the first top surface by attaching the second bottom surface to a fourth top surface of a signal amplification wafer and attaching a fourth bottom surface of said signal amplification wafer to the first top surface; the signal amplification wafer comprising at least one amplifier circuit connected between the bottom antenna pad and the signal output pad on the first top surface.

According to embodiments of this presentation, the antenna patch is provided for emitting a predetermined wavelength and has half-wavelength dimensions, wherein the at least one photodetector chip connected to the antenna patch and the at least one optical waveguide coupled to the at least one photodetector chip are located within a parallelepipedic region having lateral sides parallel to the photodetector axis and having a top side with half-wavelength dimensions.

According to embodiments of this presentation, said predetermined wavelength is in the RF band.

According to embodiments of this presentation, the optoelectronic emitter comprises a fiber optic having a distal end received in said fiber optic connector and a proximal end coupled to an electrical to optical converter.

According to embodiments of this presentation, the light detection wafer comprises a through-wafer cavity, and wherein the at least one photodetector chip is attached to at least one wall of the cavity by direct contact with a metal that fills the cavity.

According to embodiments of this presentation, the at least one photodetector chip comprises a plurality of photodetector chips arranged each to receive light from a different one of a plurality of optical inputs on the first bottom surface and having each at least one signal output pad on the first top surface; and the at least one antenna patch comprises a plurality of antenna patches connected each by a via to a different one of a plurality of bottom antenna pads, each of said plurality of bottom antenna pads being coupled to the at least one signal output pad of a different one of said plurality of photodetector chips.

According to embodiments of this presentation, the optoelectronic emitter comprises an optical waveguide wafer having a third top surface attached to the first bottom surface and having a third bottom surface; the optical waveguide wafer comprising a plurality of optical waveguides having each a waveguide output on the third top surface and a waveguide input on the third bottom surface, each one of the plurality of optical waveguides having its waveguide output being aligned with the photodetector axis of a different one of the plurality of photodetector chips; and comprises a plurality of fiber optic connectors arranged each to receive an end of a different fiber optic being attached to the third bottom surface such that light output from each of said different fiber optics enters one of the plurality of optical waveguides by its waveguide input.

According to embodiments of this presentation, each antenna patch is provided for emitting a predetermined wavelength and has half-wavelength dimensions for said different predetermined wavelength, wherein the at least one photodetector chip connected to each antenna patch is located within a parallelepipedic region having lateral sides parallel to the photodetector axis and having a top side with the same half-wavelength dimensions as the antenna patch.

Other embodiments of this presentation include a method of manufacturing an optoelectronic emitter, the method comprising: providing a light detection wafer having first top and bottom surfaces, the light detection wafer comprising at least one photodetector chip arranged to receive light in an optical input on the first bottom surface, along a photodetector axis normal to the first bottom surface and to output an electrical signal from at least one signal output pad on the first top surface; providing an antenna wafer having a second bottom surface and having a second top surface, at least one antenna patch being arranged on the second top surface and being connected by at least one via to at least one bottom antenna pad on the second bottom surface; and attaching the second bottom surface to the first top surface such that said at least one bottom antenna pad is electrically coupled to the at least one signal output pad on the first top surface.

According to embodiments of this presentation, the method further comprises: providing an optical waveguide wafer having a third top surface and a third bottom surface; the optical waveguide wafer comprising at least one optical waveguide having a waveguide output on the third top surface and a waveguide input on the third bottom surface; attaching the third top surface to the first bottom surface such that the waveguide output is aligned with the photodetector axis; and attaching to the third bottom surface a fiber optic connector arranged to receive an end of a fiber optic such that light output from said fiber optic enters the optical waveguide by the waveguide input.

According to embodiments of this presentation, the method comprises attaching the third top surface to the first bottom surface with an attachment layer comprising at least one optical lens arranged to focus light from the waveguide output on the third top surface into the optical input on the first bottom surface.

According to embodiments of this presentation, the method comprises: providing a signal amplification wafer having a fourth top surface and a fourth bottom surface and comprising at least one amplifier circuit; and attaching the second bottom surface to the first top surface by attaching the second bottom surface to the fourth top surface and attaching the fourth bottom surface to the first top surface such that the at least one amplifier circuit is connected between the bottom antenna pad and the signal output pad on the first top surface.

According to embodiments of this presentation, the antenna patch is provided for emitting a predetermined wavelength and has half-wavelength dimensions, wherein the at least one photodetector chip connected to the antenna patch and the at least one optical waveguide coupled to the at least one

photodetector chip are located within a parallelepipedic region having lateral sides parallel to the photodetector axis and having a top side with half-wavelength dimensions.

According to embodiments of this presentation, the light detection wafer comprises a through-wafer cavity, and wherein the at least one photodetector chip is attached to at least one wall of the cavity by direct contact with a metal that fills the cavity.

According to embodiments of this presentation, the at least one photodetector chip comprises a plurality of photodetector chips arranged each to receive light from a different one of a plurality of optical inputs on the first bottom surface and having each at least one signal output pad on the first top surface; and the at least one antenna patch comprises a plurality of antenna patches connected each by a via to a different one of a plurality of bottom antenna pads coupled each to the at least one signal output pad of a different one of said plurality of photodetector chips.

According to embodiments of this presentation, the method comprises: providing an optical waveguide wafer having a third top surface and a third bottom surface; the optical waveguide wafer comprising a plurality of optical waveguides having each a waveguide output on the third top surface and a waveguide input on the third bottom surface; attaching the third top surface to the first bottom surface such that each one of the plurality of optical waveguides has its waveguide output aligned with the photodetector axis of a different one of the plurality of photodetector chips; providing a plurality of fiber optic connectors arranged each to receive an end of a different fiber optic; and attaching each of said plurality of fiber optic connectors to the third bottom surface such that light output from each of said different fiber optics enters one of the plurality of optical waveguides by its waveguide input.

According to embodiments of this presentation, each antenna patch is provided for emitting a predetermined wavelength and has half-wavelength dimensions for said different predetermined wavelength, wherein the at least one photodetector chip connected to each antenna patch is located within a parallelepipedic region having lateral sides parallel to the photodetector axis and having a top side with the same half-wavelength dimensions as the antenna patch.

Other embodiments of the presentation include an optoelectronic receiver comprising a light source wafer having first top and bottom surfaces, the light source wafer comprising at least one laser chip arranged to emit a light beam along a beam axis normal to the first bottom surface and at least one associated via between a top pad on the first top surface and a bottom pad on the first bottom surface; and an optical modulation layer having a second top surface attached to the first bottom surface and having a second bottom surface, the optical modulation layer comprising at least one opto-electronic modulator having a second top surface optical input arranged to receive the light beam from the at least one laser chip and having a second bottom surface optical output, and a second top surface electrical input that is electrically connected to the bottom pad on the first bottom surface.

According to embodiments of this presentation, said light beam is output from the first bottom surface by a laser optical output, said laser optical output being coupled to the second top surface optical input by a ball lens, and wherein said second top surface electrical input is electrically connected to the bottom pad on the first bottom surface by ball bonding.

According to embodiments of this presentation, the optoelectronic receiver comprises an antenna wafer having a third bottom surface attached to the first top surface and having a third top surface, at least one antenna patch being arranged on the third top surface and being connected by a via to a bottom antenna pad on the third bottom surface; the bottom antenna pad being electrically coupled to the top pad on the first top surface.

According to embodiments of this presentation, the third bottom surface is attached to the first top surface by attaching the third bottom surface to a fourth top surface of a signal processing wafer and attaching a fourth bottom surface of said signal processing wafer to the first top surface; the signal processing wafer comprising at least one amplifier circuit connected between the bottom antenna pad and the top pad on the first top surface.

According to embodiments of this presentation, the antenna patch is provided for receiving a predetermined wavelength and has half-wavelength dimensions, wherein the at least one laser chip and the at least one opto-electronic modulator connected to the antenna patch are located within a parallelepipedic region having lateral sides parallel to the beam axis and having a top side with half-wavelength dimensions.

According to embodiments of this presentation, said predetermined wavelength is in the RF band.

According to embodiments of this presentation, the optoelectronic receiver comprises a fiber optic connector arranged to receive an end of a fiber optic such that light output from the second bottom surface optical output is coupled into the fiber optic connector.

According to embodiments of this presentation, the optoelectronic receiver comprises a fiber optic having a distal end received in said fiber optic connector and a proximal end coupled to an optical to electrical converter.

According to embodiments of this presentation, the opto-electronic modulator comprises an input optical waveguide arranged to receive light from the second top surface optical input, wherein the optical waveguide splits into two arms that rejoin thereafter into an output optical waveguide coupled to the second bottom surface optical output, one of the two arms being coupled to the second top surface electrical input of the at least one opto-electronic modulator such that an electrical signal imparted on the electrical input of the at least one opto-electronic modulator changes a phase of light that passes through that arm, wherein when light from each modulator arm comes back together, said phase shift on one arm relative to the other creates an amplitude modulation on the light in the output optical waveguide.

According to embodiments of this presentation, the light source wafer comprises a through-wafer cavity, and wherein the at least one laser chip is attached to at least one wall of the cavity by direct contact with a metal that fills the cavity.

According to embodiments of this presentation, the at least one laser chip comprises a plurality of laser chips arranged each to emit a light beam along one of a plurality of a beam axes normal to the first bottom surface; the at least one associated via comprises a plurality of vias associated each to one of said plurality of laser chips and arranged each between one of a plurality of top pads on the first top surface and one of a plurality of bottom pads on the first bottom surface; and the at least one opto-electronic modulator having a second top surface optical input, a second bottom surface optical output and a second top surface electrical input, comprises a plurality of opto-electronic modulators having each a second top surface optical input, a second bottom surface optical output and a second top surface electrical input, the second top surface optical input of each optoelectronic modulator being arranged to receive the light beam from a different one of said plurality of laser chips, and the second top surface electrical input of each optoelectronic modulator being electrically connected to the bottom pad of the via associated to the laser chip from which the light beam is received.

According to embodiments of this presentation, the optoelectronic receiver comprises an antenna wafer having a third bottom surface attached to the first top surface and having a third top surface, a plurality of antenna patches being arranged on the third top surface and being connected each by a via to a bottom antenna pad on the third bottom surface; each bottom antenna pad being electrically coupled to a different one of the plurality of top pads on the first top surface.

According to embodiments of this presentation, each antenna patch is provided for receiving a predetermined wavelength and has half-wavelength dimensions for said different predetermined wavelength, wherein the at least one laser chip and the at least one opto-electronic modulator connected to each antenna patch are located within a parallelepipedic region having lateral sides parallel to the beam axis and having a top side with the same half-wavelength dimensions as the antenna patch.

Embodiments of this presentation also include a method of manufacturing an optoelectronic receiver, the method comprising: providing a light source wafer having first top and bottom surfaces, the light source wafer comprising at least one laser chip arranged to emit a light beam along a beam axis normal to the first bottom surface and at least one associated via between a top pad on the first top surface and a bottom pad on the first bottom surface; attaching a second top surface of an optical modulation layer to the first bottom surface, said optical modulation layer having a second bottom surface and comprising at least one opto-electronic modulator having a second top surface optical input and a second top surface electrical input, and a second bottom surface optical output, such that the second top surface optical input receives the light beam from the at least one laser chip and the second top surface electrical input is electrically connected to the bottom pad on the first bottom surface.

According to embodiments of this presentation, said light beam is output from the first bottom surface by a laser optical output, the method further comprising coupling said laser optical output to the second top surface optical input with a ball lens, and electrically connecting said second top surface electrical input to the bottom pad on the first bottom surface by ball bonding.

According to embodiments of this presentation, the method further comprises attaching a third bottom surface of an antenna wafer to the first top surface, the antenna wafer having a third top surface with at least one antenna patch being arranged on the third top surface and being connected by a via to a bottom antenna pad on the third bottom surface; said attaching a third bottom surface of an antenna wafer to the first top surface comprising electrically coupling the bottom antenna pad to the top pad on the first top surface.

According to embodiments of this presentation, said attaching a third bottom surface of an antenna wafer to the first top surface comprises attaching the third bottom surface to a fourth top surface of a signal processing wafer and attaching a fourth bottom surface of said signal processing wafer to the first top surface such that at least one amplifier circuit in the signal processing wafer is connected between the bottom antenna pad and the top pad on the first top surface.

According to embodiments of this presentation, the antenna patch is provided for receiving a predetermined wavelength and has half-wavelength dimensions, wherein the at least one laser chip and the at least one opto-electronic modulator connected to the antenna patch are located within a parallelepipedic region having lateral sides parallel to the beam axis and having a top side with half-wavelength dimensions.

According to embodiments of this presentation, the method further comprises attaching a fiber optic connector arranged to receive an end of a fiber optic to the second bottom surface such that light output from the second bottom surface optical output is coupled into the fiber optic connector.

According to embodiments of this presentation, the opto-electronic modulator comprises an input optical waveguide arranged to receive light from the second top surface optical input, wherein the optical waveguide splits into two arms that rejoin thereafter into an output optical waveguide coupled to the second bottom surface optical output, one of the two arms being coupled to the second top surface electrical input of the at least one opto-electronic modulator such that an electrical signal imparted on the electrical input of the at least one opto-electronic modulator changes a phase of light that passes through that arm, wherein when light from each modulator arm comes back together, said phase shift on one arm relative to the other creates an amplitude modulation on the light in the output optical waveguide.

According to embodiments of this presentation, the light source wafer comprises a through-wafer cavity, the method comprising attaching the at least one laser chip to at least one wall of the cavity by direct contact with a metal that fills the cavity.

According to embodiments of this presentation, the at least one laser chip comprises a plurality of laser chips arranged each to emit a light beam along one of a plurality of a beam axes normal to the first bottom surface; the at least one associated via comprises a plurality of vias associated each to one of said plurality of laser chips and arranged each between one of a plurality of top pads on the first top surface and one of a plurality of bottom pads on the first bottom surface; and the at least one opto-electronic modulator having a second top surface optical input, a second bottom surface optical output and a second top surface electrical input comprises a plurality of opto-electronic modulators having each a second top surface optical input, a second bottom surface optical output and a second top surface electrical input, the second top surface optical input of each optoelectronic modulator being arranged to receive the light beam from a different one of said plurality of laser chips and the second top surface electrical input of each optoelectronic modulator being electrically connected to the bottom pad of the via associated to the laser chip from which the light beam is received.

According to embodiments of this presentation, the at least one antenna patch comprises a plurality of antenna patches connected each to a different bottom antenna pad electrically connected to a different one of the plurality of top pads.

According to embodiments of this presentation, each antenna patch is provided for receiving a predetermined wavelength and has half-wavelength dimensions for said different predetermined wavelength, wherein the at least one laser chip and the at least one opto-electronic modulator connected to each antenna patch are located within a parallelepipedic region having lateral sides parallel to the beam axis and having a top side with the same half-wavelength dimensions as the antenna patch.

### FIGURES

The above features will now be described in more details in relation with the following figures, wherein:

FIG. 1 illustrates a cross section of a receiver RF phased array comprising optoelectronic receivers according to embodiments of this presentation.

FIGS. 2A, 2B and 2C illustrate steps of manufacturing of the RF phased array of FIG. 1.

FIG. 2D illustrates a detail of an optoelectronic receiver according to embodiments of this presentation.

FIG. 3 illustrates a method of manufacturing a receiver phased array such as illustrated in FIG. 1.

FIG. 4 illustrates a transceiver phased array comprising optoelectronic receivers according to embodiments of this presentation.

FIG. 5 illustrates a method of fabricating an optoelectronic receiver according to embodiments of this presentation.

FIG. 6 illustrates a cross section of an emitter RF phased array comprising optoelectronic emitters according to embodiments of this presentation.

FIGS. 7A, 7B and 7C illustrate steps of manufacturing of the RF phased array of FIG. 6.

FIG. 8 illustrates a method of manufacturing an emitter phased array such as illustrated in FIG. 6.

FIG. 9 illustrates details of an optoelectronic emitter according to embodiments of this presentation.

FIG. 10 illustrates a transceiver phased array comprising optoelectronic receivers according to embodiments of this presentation.

FIG. 11 illustrates an emitter phased array coupled to a control module according to embodiments of this presentation.

FIG. 12 illustrates a method of fabricating an optoelectronic emitter according to embodiments of this presentation.

### DETAILED DESCRIPTION

The following description is presented to enable one of ordinary skill in the art to make and use the teachings of this presentation and to incorporate them in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of embodiments of this presentation. However, it will be apparent to one skilled in the art that such embodiments may be practiced without necessarily being limited to these specific details.

All the features disclosed in this presentation, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112(f). In particular, the use of “step of’ or “act of’ in the claims herein is not intended to invoke the provisions of 35 U.S.C. 112, Paragraph 6.

Embodiments of this presentation allow manufacturing compact arrays of receiver channels in a RF phased array, by using closely-spaced lasers positioned vertically to produce each a laser signal, an aligned set of modulators that impart the RF signal onto each laser signal, and optical interconnects to produce the outgoing RF beam. Such embodiments can be combined with a RF transmitter channel array disclosure such as detailed hereafter. It is noted that the embodiments of this presentation that are directed at handling RF signals can be replaced by embodiments directed at handling mmW signals, with appropriate dimension changes. Thus, embodiments of this presentation W-band or G-band military grade phase arrays, as well as applications that directly connect a fiber internet connection with a phase-adjusted signal to a dish antenna and that communicates with a GEO/LEO satellite, or a portion of a mmW radar module on a vehicle for sensing and obstacle detection.

Generally speaking, embodiments of this presentation comprise arranging high-power edge-emitting laser chips in a 2D array, such that each laser emits a beam along a direction normal to a plane of the array. Each laser chip is preferably a continuous wave (CW) laser that emits a constantly-on signal. The laser chips, which have a laser cavity with a cavity axis and a length that include the length of the laser cavity, are arranged with their cavity axis normal to the plane of the array. As the laser chips have a thickness and a width that are each smaller than the chip length, this arrangement allows forming a 2D array where a pitch between a same point of two consecutive laser chips is smaller than the length of a laser chip. According to embodiments of this presentation, the laser chips are all embedded in a metal-filled recess of a light source wafer. The metal embedding of the laser chips advantageously allows to efficiently evacuate the heat produced by the laser chips. This allows using high-power edge-emitting lasers which can produce high heat fluxes above ~1 kW/cm2.

As detailed hereafter, embodiments of this presentation use the 2D high-power laser array as the source of an array of CW optical signals that each acts as an optical carrier that can be RF-modulated. For example, embodiments of this presentation send the array of CW optical signals in output of the 2D laser array into a 2D array of vertically oriented modulators such as 4-port Mach Zehnder modulators, where one arm of the modulator has two electrical pads that receive in input a RF signal from an associated antenna patch of a 2-D array of RF antenna patches. In each modulator, a CW light/optical signal from a laser is split between the two arms of the modulator, where one arm gets tuned in phase based on the RF signal before the light from the two arms comes back together. A light signal output by the vertical modulator layers therefore has RF modulation imparted onto the CW optical signal. As also detailed hereafter, the above embodiments can be implemented using a 3D stacking of electronic, optoelectronic and optical wafers, with the interconnects between the layers comprising electrical interconnects (such as solder bump/ball) aligned with electrical pads and/or optical interconnects (such as ball lens) aligned with optical input/outputs.

The above embodiment allow for the leveraging of low-loss (nearly zero loss) fiber connections between individual elements in the 3D stack. In other words, the 3D stack can be split up into substacks and spread apart with fiber connections in between them, preventing added signal loss that would otherwise appear when separating out the layers. Other embodiments of this presentation can be scaled to even higher frequency than RF bands. It is to be noted that a Low Noice Amplifier (LNA) can be provided between each antenna patch and the input of its associated optical modulator. The LNAs can be arranged in a dedicated layer/wafer that is attached between the antenna array and the light source wafer.

Embodiments of this presentation allow manufacturing compact arrays of receiver channels in a RF phased array, by using closely-spaced lasers positioned vertically to produce each a laser signal, an aligned set of modulators that impart the RF signal onto each laser signal, and optical interconnects to produce the outgoing RF beam. Such embodiments can be combined with a RF transmitter channel array such as detailed hereafter. It is noted that the embodiments of this presentation that are directed at handling RF signals can be replaced by embodiments directed at handling mmW signals, with appropriate dimension changes. Thus, embodiments of this presentation W-band or G-band military grade phase arrays, as well as applications that directly connect a fiber internet connection with a phase-adjusted signal to a dish antenna and that communicates with a GEO/LEO satellite, or a portion of a mmW radar module on a vehicle for sensing and obstacle detection.

Generally speaking, embodiments of this presentation comprise arranging a plurality of high speed photodetector chips, where each photodetector chip is provided for receiving light on an input edge of the chip along an axis parallel to a surface of the chip, in a 2D array such that the axis of each photodetector chip is normal to a plane of the array. Each photodetector chip is for example a waveguide-based photodetector chip, where the waveguide can be manufactured using photolithography on a surface of the chip; the axis of the chip being parallel to said surface of the chip. The high-speed photodetector chips can be made of SiGe or Ge for near IR optical wavelengths, but they can also be made of other materials, depending on the target wavelength of the light they are provided to receive. According to embodiments of this presentation, the photodetector chips are all embedded in a metal-filled through-wafer recess of a light detection wafer. The metal embedding of the photodetector chips allows to efficiently evacuate the heat produced by the photodetector chips when operating at elevated speeds. This allows using high-speed edge-input photodetectors to receive for example RF-modulated optical signals, or mmW modulated optical signals, and transform these optical signals into electrical signals. Advantageously, noting that the edge-input photodetector chips have a thickness and a width that are each smaller than the chip length along the photodetector axis, arranging the chips with their axis normal to a plane of the array allows forming a 2D array where a pitch between a same point of two consecutive photodetector chips is smaller than the length of a photodetector chip.

As detailed hereafter, embodiments of this presentation use a high-speed photodetectors 2D array to receive simultaneously a plurality of modulated optical signals (for example RF-modulated) and transform them into a plurality of electrical signals (for example RF signals) to be emitted each by an associated antenna patch of a plurality of antenna patches of a phased array emitter. As also detailed hereafter, the above embodiments can be implemented using a 3D stacking of electronic, optoelectronic and optical wafers, with the interconnections between the layers comprising electrical interconnects (such as solder bump/ball) aligned with electrical pads and/or optical interconnects (such as ball lens) aligned with optical input/outputs.

Overall, embodiments of this presentation allow for the leveraging of low-loss (nearly zero loss) fiber connections between the 3D stack phased array and circuits generating the signals to be sent by the phased array. Embodiments of this presentation comprise a RF phased array but other embodiments can be scaled to even higher frequency than RF bands. As detailed hereafter, a Low Noice Amplifier (LNA) can optionally be provided between each antenna patch and the output of its associated photodetector, depending on the output power of the photodetectors. The LNAs can be arranged in a dedicated layer/wafer that is attached between the antenna array and the light detection wafer.

Embodiments of this presentation allow manufacturing compact arrays of emitter channels in a RF phased array, by using closely-spaced photodetectors positioned vertically to receive each a different light signal and transform the light signal into a RF signal, each RF signal being communicated to a different antenna patch of an antenna array to produce an outgoing RF radiation beam. Such embodiments can be combined with a RF emitter channel array such as detailed previously. It is noted that the embodiments of this presentation that are directed at handling RF signals can be replaced by embodiments directed at handling mmW signals, with appropriate dimension changes. Thus, embodiments of this presentation W-band or G-band military grade phase arrays, as well as applications that directly connect a fiber internet connection with a phase-adjusted signal to a dish antenna and that communicates with a GEO/LEO satellite, or a portion of a mmW radar module on a vehicle for sensing and obstacle detection.

Another possible consumer application of embodiments of this presentation lies in wireless power, where the ability to beam electrical power across a room typically requires lots of beam steering using a phased array. Embodiments of this presentation would allow to have less loss from a power generator to an output antenna.

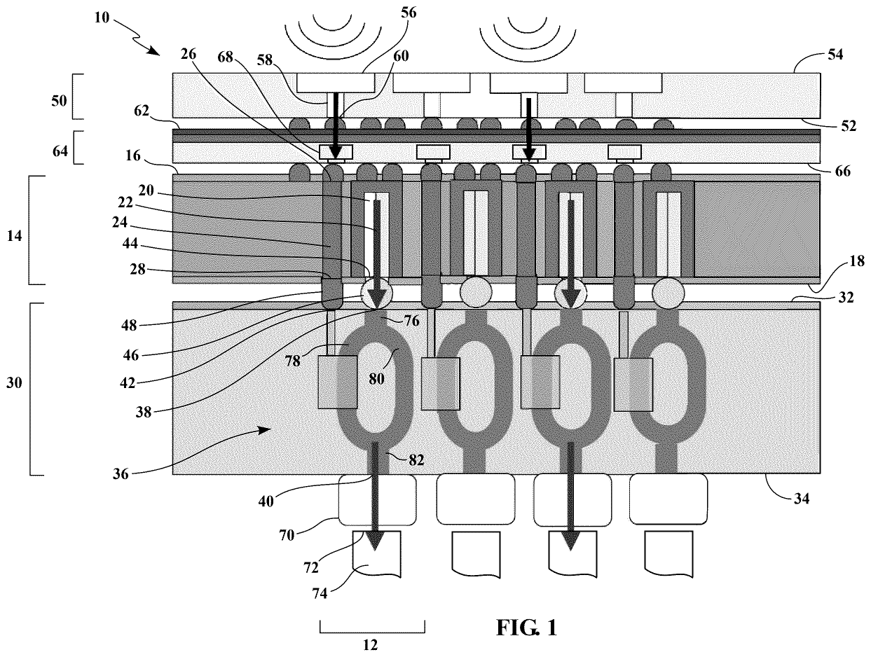

FIG. 1 illustrates a cross section of embodiments of this presentation where an optoelectronic receiver forms a receiver RF phased array 10 comprising a plurality of receiver structures 12. According to embodiments of this presentation, each receiver structure 12 comprises: a light source wafer 14 having a top surface 16 and a bottom surface 18, wherein the light source wafer 14 comprises at least one laser chip 20 arranged to emit a light beam 22 along a beam axis normal to bottom surface 18 and comprises at least one associated via 24 between a top pad 26 on top surface 16 and a bottom pad 28 on bottom surface 18. According to embodiments of this presentation, each receiver structure 12 further comprises an optical modulation layer 30 having a top surface 32 that is attached to bottom surface 18 and having a bottom surface 34. The optical modulation layer 30 comprises at least one opto-electronic modulator 36 that is associated to the at least one laser chip 20. According to embodiments of this presentation, opto-electronic modulator 36 comprises an optical input 38 that is located on top surface 32 and that is arranged to receive the light beam 22 from its associated laser chip 20. Opto-electronic modulator 36 further comprises an optical output 40 located on bottom surface 34 and an electrical input 42 that is located on top surface 32 and is electrically connected to the bottom pad 28 on bottom surface 18.

According to embodiments of this presentation, light beam 22 is output from the bottom surface 18 by a laser optical output 44, wherein laser optical output 44 is coupled to the second top surface optical input 38, for example using a ball lens 46; and top surface electrical input 42 is electrically connected to bottom pad 28 on bottom surface 18 by an electrically conductive ball bonding 48. According to this presentation, each electrical interconnect solder ball is chosen such that its diameter allows for minimal loss and maximal coupling of the electrical that passes through it.

According to embodiments of this presentation, receiver structure 12 also comprises an antenna layer or wafer 50, with a bottom surface 52 attached to the top surface 16 of the light source wafer 14 and a top surface 54 comprising at least one antenna patch 56. Antenna patch 56 can be connected by a via 58 to a bottom antenna pad 60 on bottom surface 52; the bottom antenna pad 60 being electrically coupled to the top pad 26 on the top surface 16 of of the light source wafer 14.

Optionally, the bottom surface 52 of the antenna wafer 50 can be attached to the top surface 16 of the light source wafer 14 by attaching bottom surface 52 to a top surface 62 of a signal processing wafer 64 and attaching a bottom surface 66 of signal processing wafer 64 to the top surface 16 of the light source wafer 14; the signal processing wafer comprising at least one amplifier circuit 68 (preferably a Low Noise Amplifier) connected between the bottom antenna pad 60 and the top pad 26 on the top surface 16.

According to embodiments of this presentation, antenna patch 56 is provided for receiving a predetermined wavelength λ and has half-wavelength dimensions, wherein the at least one laser chip 22 and the at least one opto-electronic modulator 36 connected to the antenna patch 56 are located within a volume forming a parallelepipedic region that has lateral sides parallel to the axis of light beam 22 and has a top side with half-wavelength dimensions (each dimension of the top side being smaller than or equal to λ/2×λ/2). According to embodiments of this presentation, the predetermined wavelength λ corresponds to a frequency in the RF band.

According to embodiments of this presentation, optoelectronic receiver 12 further comprises a fiber optic connector 70 arranged to receive an end 72 of a fiber optic 74 such that light output from the optical output 40 of the opto-electronic modulator 36 is coupled into fiber optic 74. According to embodiments of this presentation, receiver structure 12 comprises a fiber optic 74 having a distal end 72 received in fiber optic connector 70 and a proximal end (not shown in FIG. 1) coupled to an optical to electrical converter (also not shown in FIG. 1).

According to embodiments of this presentation, the opto-electronic modulator 36 comprises an input optical waveguide 76 arranged to receive light from optical input 42, wherein the optical waveguide 76 splits into two arms 78 and 80 that rejoin at a distance into an output optical waveguide 82 coupled to optical output 40, and wherein arm 78 is coupled to electrical input 42 such that an electrical signal imparted on electrical input 42 can change a phase of a light that passes through arm 78. Preferably, opto-electronic modulator 36 is a Mach-Zender modulator and electrical input 42 comprises two conductors connected to two electrodes arranged to generate an electromagnetic field that passes through arm 78 and generates the phase shift of the light. Modulator 36 is then arranged such that when light from modulator arms 78 and 80 come back together in output optical waveguide 82, the phase shift on one arm relative to the other creates an amplitude modulation on the light in the output optical waveguide 82.

As outlined above, a receiver 12 according to embodiments of this presentation is particularly adapted to form a receiver RF phased array. As illustrated in FIG. 1, the “at least one” laser chip 20 can comprise a plurality of laser chips 20 arranged in an array such that each laser chip 20 emits a light beam 22 along one of a plurality of a beam axes normal to bottom surface 18. In such embodiments, the “at least one” associated via 22 comprises a plurality of vias associated each to one of the plurality of laser chips 20; each via being arranged between a respective top pad 26 and a respective bottom pad 28. Similarly in such embodiments, the “at least one” opto-electronic modulator comprises a plurality of

opto-electronic modulators 36 having each a respective optical input 38 arranged to receive the light beam 22 from a respective one of said plurality of laser chips 20 and having a respective optical output 40, as well as a respective electrical input 42 that is electrically connected to the bottom pad 28 of the via 24 associated to the laser chip 20 from which the light beam 22 is received. Consistently, in such embodiments the “at least one” antenna patch 56 comprises a plurality of antenna patches 56 connected each to a different bottom antenna pad 60 electrically connected to a respective one of the plurality of top pads 26.

As outlined previously, each antenna patch 56 can be provided for receiving a predetermined wavelength λ and has half-wavelength dimensions for said different predetermined wavelength, wherein the laser chip 20 and the opto-electronic modulator 36 forming the receiver connected to each antenna patch 56 are located within a parallelepipedic region having lateral sides parallel to the beam axis and having a top side with the same half-wavelength dimensions as the antenna patch. Because each receiver has such reduced dimensions in directions parallel to the plane of the array of antenna patches 56, embodiments of this presentation allow manufacturing a very dense RF phased array receiver, where circuitry that transforms the RF signals received by the antenna patches of the array into modulated light signals are located nearly immediately below the antenna patches, thus advantageously addressing the signal loss concerns previously met in the art.

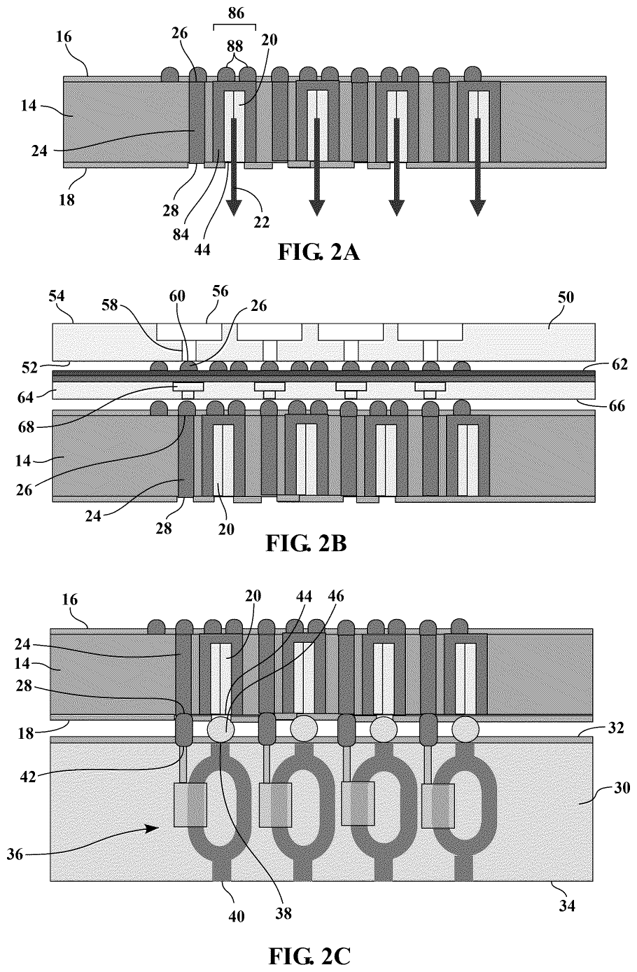

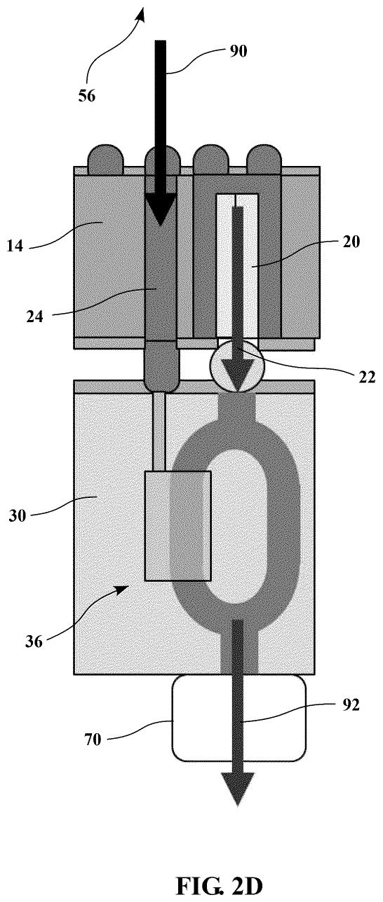

FIGS. 2A, 2B and 2C illustrate steps of manufacturing of the RF phased array of FIG. 1. FIG. 2A illustrates light source wafer 14, for example such as obtained after manufacturing. As outlined previously, light source wafer 14 comprises a plurality of laser chips 20 each arranged to emit a light beam 22 through an optical output 44 in bottom surface 18 along a direction normal to bottom surface 18. In the embodiment illustrated, each laser chip 20 is a side-emitting chip and is attached to wafer 14 by direct contact with a metal 84 that fills a through-wafer cavity 86 of wafer 14. Preferably, the height of the wafer 14, and therefore the depth of through-wafer cavity 86, are larger than the length of the

laser chip 20 in the direction of emission of light beam 22. In the embodiment illustrated, laser chip 20 is coupled to a plurality of electrical pads 88 that are electrically connected to control pads (not shown) of the laser chip 20, such that laser chip 20 can be controlled by inputting electrical signals to pads 88. Attachment of laser chip 20 in through-wafer cavity 86 by metal 84 can be done as a MECA assembly as described in U.S. Pat. No. 10,998,273; which is hereby incorporated by reference. FIG. 2A is a cross section of a 2D array, and a single through-wafer cavity 86 extending in a direction normal to the plane of the drawing can comprise a plurality of laser chips 20 arranged at a distance from each other in said direction. Alternatively, a plurality or through-wafer cavities 86 arranged at a distance from each other in a direction normal to the plane of the drawing can comprise each one of a plurality of laser chips 20. As outlined previously, at least one via 24 is associated with each laser chip 20. According to embodiments of this presentation, said “at least one” via 24 comprises a pair of vias 24 (only one shown) capable of transmitting for example a RF signal and a ground. According to embodiments of this presentation, wafer 14 can be a silicon wafer. It can be passivated both on top and bottom surfaces 16, 18, with opening in the passivation for access to the electrical pads as well as the optical output 44 of each laser chip 20.

FIG. 2B illustrates an assembly of light source wafer 14 with antenna wafer 50 and optional signal processing wafer 64. In the embodiment illustrated, antenna wafer 50 has a top surface 54 where a 2-D array of antenna patches 56 is arranged, for example along rows and columns. Wafer 50 can be a ceramic wafer (wafer 50 can be any suitable antenna substrate, also including semiconductor, glass or organic substrates such as known under the commercial names of FR-4 or Rogers) and the patches can be formed by sputtering or electrometallurgy. The patches 56 can be dimensioned and distanced from each other so as to receive a predetermined wavelength λ. Each patch 56 can be connected to a pad 60 on a bottom surface 52 of wafer 50 by a via 58. A ground plane (not shown) of wafer 50 can also be connected to a pad on bottom surface 52.

Signal processing wafer 64 can be a silicon wafer (Signal processing wafer 64 can be any RF wafer, including MMIC, Si, SiC-based or reconstituted) with a plurality of integrated LNAs 68. Alternatively, signal processing wafer 64 can be a wafer of a first material (such as silicon) comprising a plurality of LNA chips 68 of another material (Such as GaN) embedded each (using an electroplated metal filling) in a through-wafer cavity of the wafer(consistently with the teachings of U.S. Pat. No. 10,998,273 cited previously). Signal processing wafer 64 can comprise a SOI wafer wafer; but it can also comprise a compound semiconductor material such as an epitaxial GaN wafer. The LNAs 68 are connected to input contact pads on the top surface 62 of wafer 64, themselves connected by e.g. ball bonding to output pads 60 of the wafer 50 so that each LNA 68 can receive in input the RF signals received on one respective antenna patch 56. The LNAs 68 are connected to output contact pads on the bottom surface 66 of wafer 64 so that each LNA 68 can generate in output an amplified RF signal (i.e. including a signal and a ground) it receives in input. The output pads of wafer 64 are respectively connected by e.g. ball bonding to pads 26 on the top surface of wafer 14 such that the amplified RF signal can be transmitted through vias 24 to related pads 28 on the bottom surface 18 of wafer 14.

FIG. 2C illustrates an assembly of light source wafer 14 with optical modulation layer 30. As outlined above, the optical output 44 of each embedded laser chip 20 of wafer 14 is coupled to the optical input 38 of a respective modulator 36 of layer 30, for example using a respective lens 46 that can be glued in place. Alternatively, the coupling can simply use a transparent resin. Consistently, the electrical input pads 42 of the modulators 36, located on top surface 32 of layer 30, are electrically connected e.g. by ball bonding to the bottom pad 28 on bottom surface 18 of wafer 14. This allows the amplified RF signal from each antenna patch to control the modulation of a CW light from wafer 14 by a respective modulator of layer 30. According to embodiments of this presentation, the modulators 36 can be manufactured separately by lithography on substrates having appropriate refractive indexes, for example glass substrates, with their axis parallel to the substrates, before being separated by dicing and being assembled into a plane layer 30 with their axis normal to the plane of layer 30, for example using a resin. Alternatively, the modulators 36 can be manufactured in-substrate, for example using a volumetric 3D printing process (where patterning the substrate changes the dielectric constant where exposed)

FIG. 2D illustrates a detail of an optoelectronic receiver according to embodiments of this presentation, having a laser chip 20 in wafer 14, associated to a modulator 36 in layer 30. A RF signal 90 from an antenna patch 56 (not shown), eventually amplified by a LNA 68 (also not shown) is passed through wafer 14 by via 24 to the electrical input of the modulator 35, which receives on its optical input the CW light 22 output by laser chip 20. Modulator 36 outputs on fiber optics connector 70 a RF modulated light signal 92, which is the CW light 22 modulated by RF electrical signal 90.

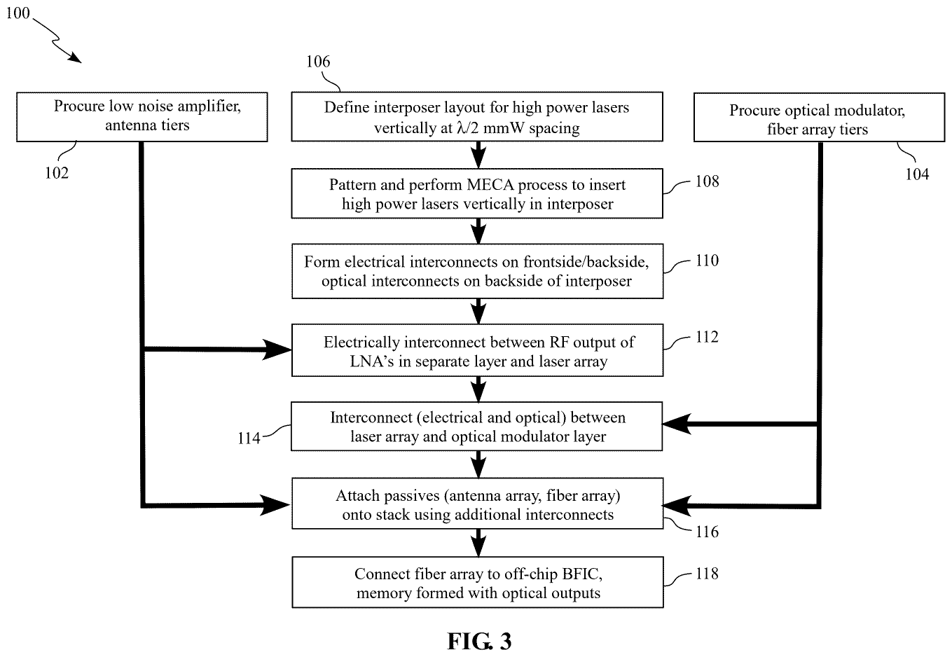

FIG. 3 illustrates a method 100 of manufacturing a receiver phased array such as illustrated in FIG. 1. According to embodiments of this presentation, the method comprises procuring 102 antenna wafer 50, optionally providing an amplifier wafer 64 that can be attached to the bottom surface of antenna wafer 50; and procuring 104 modulator layer 30, where antenna wafer 50 comprises an array of antenna patches 56 dimentioned and arranged to receive a predetermined wavelength; where amplifier wafer 64 comprises an array of amplifiers 68 that can each be vertically aligned with one antenna patch of antenna wafer 50; and where modulator layer 30 comprises an array of modulators 36 that can each be vertically aligned with one antenna patch of antenna wafer 50. The method further comprises defining 106 an interposer layout for laser chips 20 such that each laser chip 20 can also be aligned with one antenna patch of antenna wafer 50. The method then comprises patterning 108 a wafer 14 to form through-wafer cavities for receiving each at least one of the laser chips 20. The method then comprises forming 110 the electrical interconnects on the top and bottom surfaces (frontside and backside) of wafer 14, and optionally the optical interconnects on the bottom surface of wafer 14.

The method then comprises optionally attaching 112 the bottom surface of optional amplifier wafer 64 to the top surface of wafer 14, such that the output of each amplifier 68 of amplifier wafer 64 is electrically coupled to at least a via associated with a respective laser chip 20. The method further comprises attaching 114 the top surface of modulator layer 30 to the bottom surface of wafer 14 such that each modulator 36 receives in input a CW light from a laser chip 20 of wafer 14 and a RF signal from one antenna patch 56 of wafer 50, through a via in wafer 14. Finally, the method comprises attaching 116 antenna wafer 50 to the top surface of wafer 14, optionally of wafer 64, such that each antenna patch 56 can transmit a RF signal, optionally an amplified RF signal, to the electrical input of a respective modulator 36 of layer 30; and attaching optic fiber connectors 70 and eventually optic fibers to the bottom surface of layer 30 to receive the optical output of each modulator 36.

Optionally, the method comprises connecting 118 the connectors 70 or optic fibers coupled to the connectors to remote optoelectronics provided for processing the modulated light 92 output by the modulators 36.

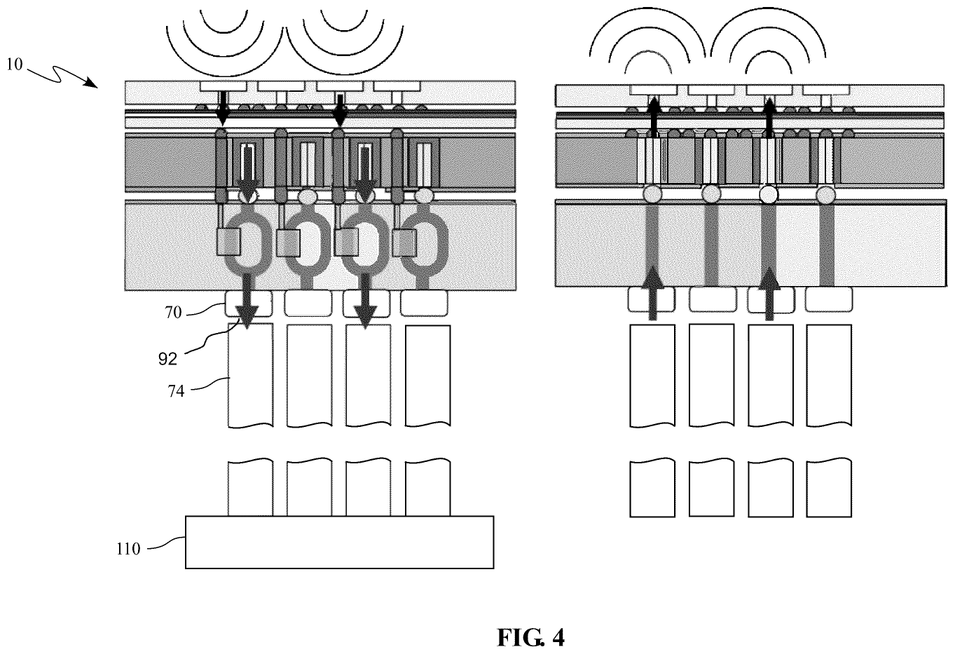

FIG. 4 illustrates a transceiver phased array according to embodiments of this presentation, including a receiver phased array 10 such as illustrated in FIG. 1, wherein a plurality of optical fibers 74 coupled to connectors 70 are arranged to transmit the modulated light 92 output by the modulators 36 to optoelectronic receivers 110. Advantageously, optoelectronics 110 can be distant from phased array 10 as the optical fibers 74 incur little or no signal loss. For example, optical fiber loss 0.3 dB/km-3.5 dB/km can be achieved, making it possible to place phased array unit remote from a baseband processing unit. This figure can be compared to transmission line losses that can be >1.42 dB/cm above 40 GHz. According to embodiments of this presentation, when frequencies of the order of 100 GHz are considered, converting electrical RF signals to optical signals and transmitting on optical fiber/waveguide can enable RF signals to travel larger distances at low insertion loss. Advantageously, arranging optoelectronics 110 at a distance from phased array 10 also allows better thermal control of the combination.

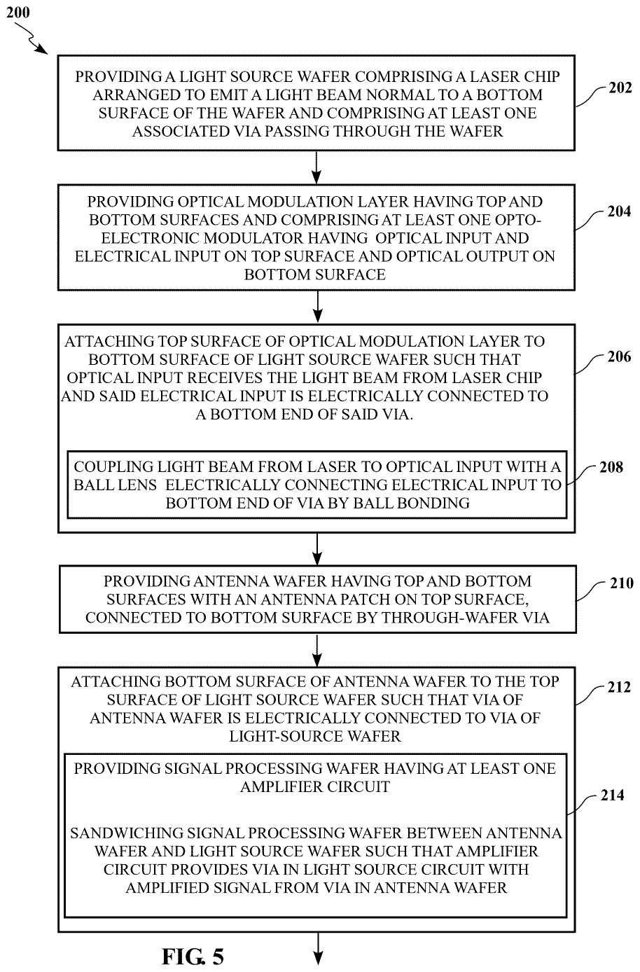

FIG. 5 illustrates a method 200 of fabricating an optoelectronic receiver according to embodiments of this presentation.

Method 200 comprises providing 202 a light source wafer comprising a laser chip arranged to emit a light beam normal to a bottom surface of the wafer and comprising at least one associated via passing through the wafer; providing 204 an optical modulation layer having top and bottom surfaces and comprising at least one opto-electronic modulator having with optical input and electrical input on top surface and optical output on bottom surface; and attaching 206 top surface of optical modulation layer to bottom surface of light source wafer such that optical input receives the light beam from laser chip and said electrical input is electrically connected to a bottom end of said via.

According to embodiments of this presentation, method 200 further comprises coupling 208 the light beam from the laser chip to the optical input with a ball lens, and electrically connecting electrical input to bottom end of via by ball bonding. According to embodiments of this presentation, method 200 further comprises providing 210 an antenna wafer having top and bottom surfaces with an antenna patch on top surface, connected to bottom surface by through-wafer via; and attaching 212 the bottom surface of the antenna wafer to the top surface of the light source wafer such that via of the antenna wafer is electrically connected to the via of the light-source wafer.

Optionally, method 200 comprises providing 214 a signal processing wafer having at least one amplifier circuit and sandwiching the signal processing wafer between the antenna wafer and the light source wafer such that the amplifier circuit provides the via in the light source circuit with an amplification of a signal from the via in the antenna wafer.

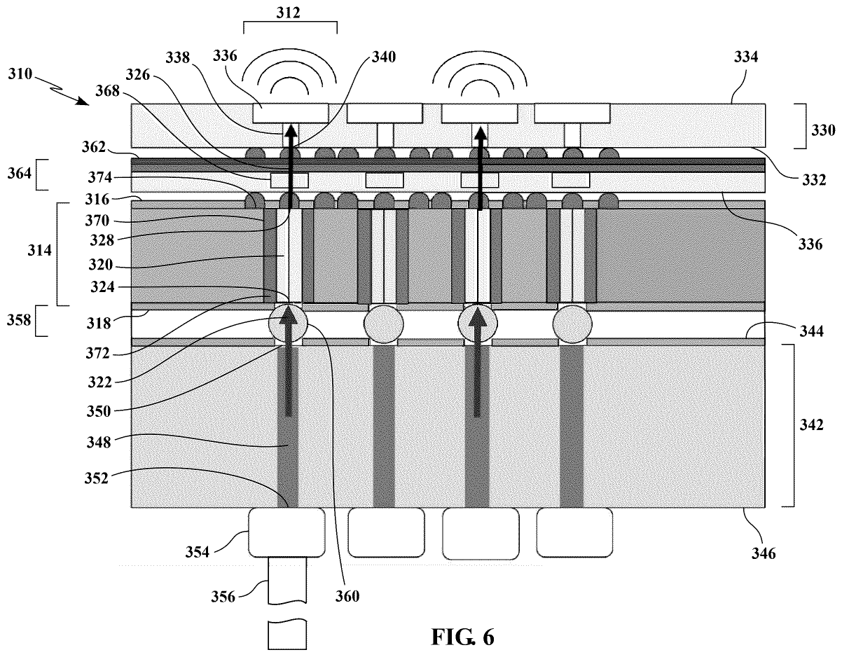

FIG. 6 illustrates a cross section of an optoelectronic emitter 310 according to embodiments of this presentation, where the optoelectronic emitter 310 is a RF phased array comprising a plurality of emitter structures 312, wherein each emitter structure 312 comprises a light detection wafer 314 having a first top surface 316 and a first bottom surface 318, the light detection wafer 314 comprising at least one photodetector chip 320 arranged to receive light 322 in an optical input 324 on the first bottom surface 318, along a photodetector axis normal to the first bottom surface 318. Photodetector chip 320 is provided to convert light 322 into an electrical signal 326 output by at least one signal output pad 328 on the first top surface 316. The at least one output pad 328 can comprise one signal pad and one ground pad. The ground pad can be common to a plurality of photodetectors. The emitter structure 312 further comprises an antenna wafer 330 having a second bottom surface 332 attached to the first top surface 316 and a second top surface 334, wherein at least one antenna patch 336 is arranged on the second top surface 334 and is connected by a via 338 to at least one bottom antenna pad 340 on the second bottom surface 332. The at least one bottom antenna pad 340 is electrically coupled to the at least one signal output pad 328 on the first top surface 316. The at least one bottom antenna pad 340 can comprise one signal pad and one ground pad. The ground pad can be common to a plurality of antenna patches.

According to embodiments of this presentation, emitter structure 312 further comprises an optical waveguide wafer 342 having a third top surface 344 attached to the first bottom surface 318 and having a third bottom surface 346. Optical waveguide wafer 342 comprises at least one optical waveguide 348 having a waveguide output 350 on the third top surface 344 and a waveguide input 352 on the third bottom surface 346, where the waveguide output 350 is aligned with the photodetector axis so as to optically couple the waveguide 348 to the edge input of the photodetector 320. A proximal end of fiber optic 356 can be coupled to a circuit stack (not illustrated in FIG. 6) comprising an optical to electrical converter, a beamformer IC, a DAC, any logic or memory ICs, and any other interposers. This circuit stack can be larger in area than the optoelectronic emitter array of this presentation, relaxing some constraints on size versus if these elements were all connected beneath the power amplifier layer. This fiber-based approach leverages the low-loss inherent in fiber and optical signals so that one can spread out the different elements necessary for a transmitter channel array and thus reduce peak heat density in the stack. This approach requires only that the power amplifier, photodetector, and waveguide layers consider the RF lambda/2 spacing of each of their elements. Thus, the use of RF photonic devices in a MECA assembly interposer formation allows for more compact spacing (e.g. lambda/2) of high-speed photodetectors, better thermal control, lower signal loss in the stack, decoupling of the power amplifier and antennas from the beam formers, and better RF signal purity through the use of a RF-modulated optical source.

According to embodiments of this presentation, second bottom surface 332 is attached to the first top surface 316 by attaching second bottom surface 332 to a fourth top surface 362 of a signal amplification wafer 364 and attaching a fourth bottom surface 366 of said signal amplification wafer 364 to the first top surface 316; the signal amplification wafer comprising at least one power amplifier circuit 368 connected between the at least one bottom antenna pad 340 and the at least one

signal output pad 328 on the first top surface 316. The signal amplification layer 364 can be either a silicon-based or III-V based semiconductor (e.g. GaN) wafer, with each amplifier circuit 368 capable of reaching a target RF-modulated frequency. According to embodiments of this presentation, the signal out the top side of the photodetector 320 can be high power and high SNR enough to not require the power amplifier 368, in which case the output from the array of photodetectors 320 can be fed directly to the array of antenna patches 336.

According to embodiments of this presentation, the array of antenna patches 336 can be provided for emitting electromagnetic waves having a certain frequency/wavelength, and each antenna patch 336 can be an antenna patch of half-wavelength dimensions. In such embodiments, because the photodetector chip 320 connected to each antenna patch 336 is arranged sideways (i.e. with their axis normal to the plane of the array), and because the at least one optical waveguide 348 coupled to the photodetector chip 320 is narrow, an optoelectronic emitter according to this presentation is comprised within a parallelepipedic region having lateral sides parallel to the photodetector axis and having a top side of half-wavelength dimensions.

In other words, embodiments of this presentation comprise an array of photodetector chips/dies positioned vertically/normally with respect to a plane of the array, such that together they can constitute a layer of a RF photonic phased array. The use of a MECA structure allows for a plurality of chips to placed in proximity, solving both the issue of signal loss and the issue of thermal heat sinking. Prior approaches used a single off-chip photodetectors that were not scalable or able to be tiled in such a way that higher frequency bands (<500 um spacing) could be reached.

Accordingly, embodiments of this presentation answer a long-held need of being able to form phased arrays that leverage RF photonics and are compact enough for high frequency operation.

According to embodiments of this presentation, light detection wafer 314 comprises at least one through-wafer cavity 370 having walls, and the at least one photodetector chip 320 is attached to at least one wall of the through-wafer cavity 370 by direct contact with a metal 372 that fills the cavity. Preferably, the height of the wafer 314, and therefore the height of the walls of the through-wafer cavity 370, are larger than the length of the photodetector chip 320 along its axis. In the embodiment illustrated, photodetector chip 320 is coupled for example using isolated vias (not shown) to a plurality of electrical pads 374 that are electrically connected to control pads (also not shown) of the photodetector chip 320, such that photodetector chip 320 can output electrical signals using pads 374. The attachment of photodetector chip 320 to the wall of the through-wafer cavity 370 by metal 372 can be done as a MECA assembly as described in U.S. Pat. No. 10,998,273; which is hereby incorporated by reference.

As outlined above, FIG. 6 illustrates embodiments of this presentation where the optoelectronic emitter is a RF phased array 310 that comprises a plurality of emitter structures 312, where said at least one photodetector chip 320 effectively comprises a plurality of photodetector chips 320 arranged each to receive light from a different one of a plurality of optical inputs 324 on the first bottom surface and having each at least one signal output pad on the first top surface 318; and said at least one antenna patch 336 effectively comprises a plurality of antenna patches 336 connected each by at least one via 338 to a different one of a plurality of bottom antenna pads 340 coupled each to the at least one signal output pad 328 of a different one of said plurality of photodetector chips 320. In such embodiments, the optical waveguide wafer 342 effectively comprises a plurality of optical waveguides 348 having each a waveguide output 350 on the third top surface 344 and a waveguide input 352 on the third bottom surface 346, each one of the plurality of waveguides 348 having its waveguide output 350 aligned with the photodetector axis of a different one of the plurality of photodetector chips 320. The plurality of optical waveguides can be manufactured separately and attached together by a resin or they can be manufactured by doping locally a unique substrate such as a plate of glass. Or alternatively by 3D printing. Consistently, a plurality of fiber optic connectors 354 are arranged each to receive a distal end of a different fiber optic 356 such that light output from each of said different fiber optics 356 enters one of the plurality of optical waveguides 348 by its waveguide input 352.

In such embodiments, each antenna patch 336 can be provided for emitting at a predetermined wavelength and have half-wavelength dimensions for said different predetermined wavelength, wherein the at least one photodetector chip 320 connected to each antenna patch can be located within a parallelepipedic region having lateral sides parallel to the photodetector axis and having a top side with the same half-wavelength dimensions as the antenna patch. A RF-modulated signal converted from the light signals received by each photodetector chip 320 can be transmitted out through the antenna patch 336 associated to each photodetector chip 320 to send a phase-controlled RF beam. In a known manner, emitting a same RF signal from each antenna patch 336 while controlling for example the phase of each RF signal can allow to effectively generate a directional beam from the phased array 310.

A proximal end of fiber optic 356 can be coupled to a circuit stack (not illustrated in FIG. 6) comprising an optical to electrical converter, a beamformer IC, a DAC, any logic or memory ICs, and any other interposers. This circuit stack can be larger in area than the optoelectronic emitter array of this presentation, relaxing some constraints on size versus if these elements were all connected beneath the power amplifier layer. This fiber-based approach leverages the low-loss inherent in fiber and optical signals so that one can spread out the different elements necessary for a transmitter channel array and thus reduce peak heat density in the stack. This approach requires only that the power amplifier, photodetector, and waveguide layers consider the RF lambda/2 spacing of each of their elements. Thus, the use of RF photonic devices in a MECA assembly interposer formation allows for more compact spacing (e.g. lambda/2) of high-speed photodetectors, better thermal control, lower signal loss in the stack, decoupling of the power amplifier and antennas from the beam formers, and better RF signal purity through the use of a RF-modulated optical source.

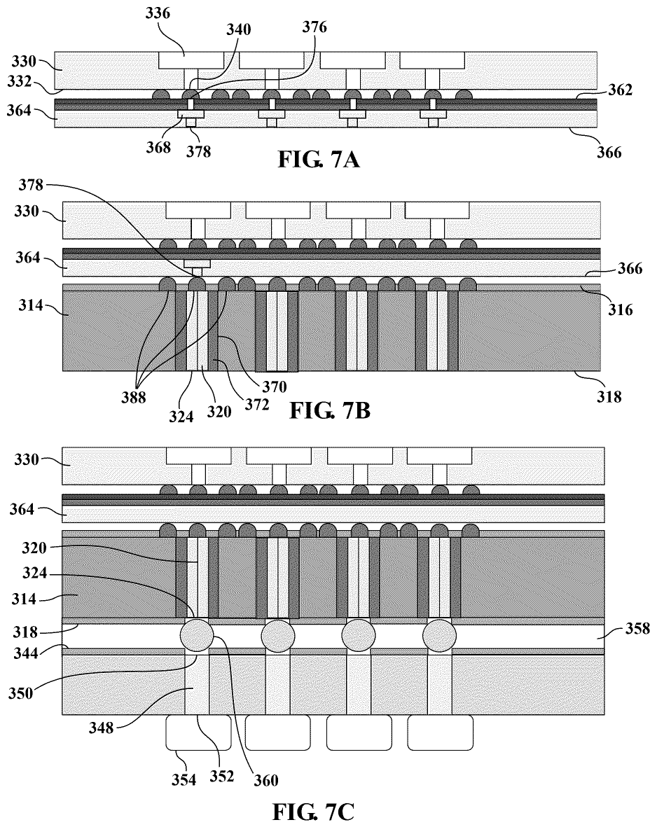

FIG. 7A illustrates a cross section of antenna wafer 330, for example such as obtained after manufacturing. As outlined previously, antenna wafer 330 comprises a 2-D array of antenna patches 336, arranged for example along rows and columns, each pad arranged to emit an electromagnetic signal (such as a RF signal) received through at least one via 338 from a bottom antenna pad 340 in bottom surface 332. Each “at least one” via 338 can comprise a signal via and a ground via if a ground plane (not shown) of antenna wafer 330 is not arranged on bottom surface 332. Wafer 330 can be a ceramic wafer (or any wafer suitable as RF substrate) and the patches 336 can be formed by sputtering or electrometallurgy. The patches 336 can be dimensioned and distanced from each other so as to emit a predetermined wavelength λ. Each patch 336 can be connected to a pad 60 on a bottom surface 52 of wafer 50 by a via 58.

FIG. 7A illustrates optional signal amplification wafer 364 attached to the bottom of antenna wafer 330. Signal amplification wafer 364 can be a silicon wafer with a plurality of integrated power amplifiers 368. Alternatively, signal amplification wafer 364 can comprise a MECA structure as taught in U.S. Pat. No. 10,998,273, including a wafer of a first material (such as silicon) carrying a plurality of power amplifier chips 368 of another material, where each power amplifier chip 368 is embedded by an electroplated metal in a through-wafer cavity of the wafer. Signal amplification wafer 364 can also be made of a compound semiconductor material (e.g. comprising GaN, GaAs or InP) using through-substrate vias to pass signals from one side of the wafer to the other. Each power amplifier 368 is connected to at least one output contact pad 376 on the top surface 362 of wafer 364 and to at least one input contact pad 378 on the bottom surface 366 of wafer 364. The at least one output pads 376 of wafer 364 are connected by e.g. ball bonding to the at least one input pads 340 in the bottom surface 332 of the antenna wafer 330, such that each amplifier 368 can receive in input a signal (e.g. RF signal, for example including a signal and a ground) from the at least one input pad 378 and transmit an amplified signal to the antenna patch 336 it is connected to.

FIG. 7B shows the light detection wafer 314 with its top surface 316 attached to the bottom surface 366 of signal amplification wafer 364. Preferably, the height of the wafer 314, and therefore the depth of through-wafer cavity 370, are larger than the length of the photodetector chip 320 along the photodetector axis. In the embodiment illustrated, photodetector chip 320 is coupled to a plurality of electrical pads 388 that are electrically connected to control pads (not shown) of the photodetector chip 320, such that photodetector chip 320 can exchange input/output electrical signals using pads 388. Pads 388 are connected to the pads 378 of wafer 364 by for example ball bondings. As outlined above, attachment of photodetector chip 320 in through-wafer cavity 370 by metal 372 can be done as a MECA assembly as described in U.S. Pat. No. 10,998,273; which is hereby incorporated by reference. In more detail, it is to be noted that a single through-wafer cavity 370 extending in a direction normal to the plane of the drawing can comprise a plurality of photodetector chips 320 arranged at a distance from each other in said direction. Alternatively, a plurality or through-wafer cavities 370 arranged at a distance from each other in a direction normal to the plane of the drawing can comprise each one of a plurality of photodetector chips 320. According to embodiments of this presentation, wafer 314 can be a silicon wafer. It can be passivated both on top and bottom surfaces 316, 318, with opening in the passivation for access to the electrical pads as well as the optical input 324 of each photodetector chip 320.

FIG. 7C shows optical waveguide wafer 342 with its top surface 344 attached to the bottom surface 318 of light detection wafer 314. As outlined above, according to embodiments of this presentation, optical waveguide wafer 342 comprises a plurality of optical waveguides 348 having each a waveguide top output 350 and a waveguide bottom input 352, where the output 350 of each waveguide is aligned with the axis of the edge input of one of the plurality of photodetectors 320, effectively coupling optically each waveguide 348 to a photodetector 320. Waveguide 348 is preferably a single mode waveguide. A fiber optic connector 354 can be attached to the third bottom surface 346 and arranged to receive an end of a fiber optic 356 such that light output from fiber optic 356 is coupled into optical waveguide 348.

According to embodiments of this presentation, the top surface 344 of waveguide wafer 342 is attached to first bottom surface 318 by an attachment layer 358 comprising a plurality of optical lenses 360 arranged each to focus light coming from the waveguide output 350 of a waveguide 348 into the optical input 324 of each photodetector chip 320 associated to the waveguide 348. Attachment layer 358 can be made of a resin gluing first bottom surface 318 to third top surface 344 while maintaining optical lens 360 in place. Alternatively, optical lenses 360 can be replaced each by a transparent region (not illustrated) not acting as a lens.

According to embodiments of this presentation, the waveguides 348 can be manufactured separately by lithography on substrates having appropriate refractive indexes, for example glass substrates, with their axis parallel to the substrates, before being separated by dicing and being assembled into a plane wafer 342 with

their axis normal to the plane of wafer 342, for example using a resin. Alternatively, the waveguides can be manufactured in one go by 3-D printing.

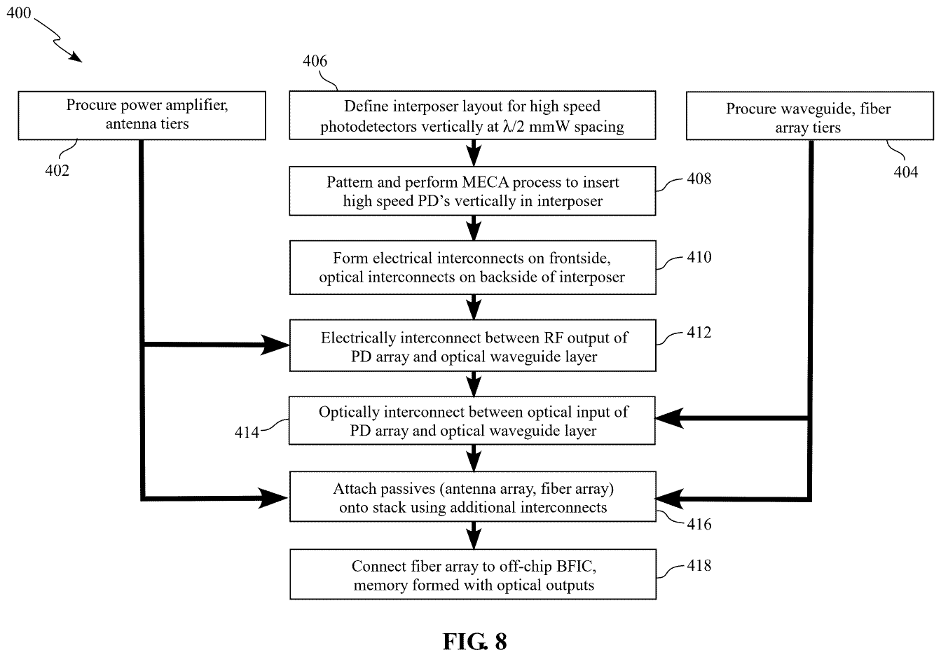

FIG. 8 illustrates a method 400 of manufacturing an emitter phased array such as illustrated in FIG. 6. According to embodiments of this presentation, the method comprises procuring 402 antenna wafer 330, optionally providing a power amplifier wafer 364 that can be attached to the bottom surface of antenna wafer 330; and procuring 404 waveguide layer 342, where antenna wafer 330 comprises an array of antenna patches 336 dimentioned and arranged to emit a predetermined wavelength; where amplifier wafer 364 comprises an array of amplifiers 368 that can each be each vertically aligned with one antenna patch of antenna wafer 330; and where waveguide layer 342 comprises an array of waveguides 348 that can each be vertically aligned with one antenna patch of antenna wafer 330. The method further comprises defining 406 an interposer layout for photodetector chips 320 such that each photodetector chip 320 can also be aligned with one antenna patch of antenna wafer 330. The method then comprises patterning 408 a wafer 314 to form through-wafer cavities 370 for receiving each at least one of the photodetector chips 320. The method then comprises forming 410 the electrical interconnects on the top and bottom surfaces (frontside and backside) of wafer 314, and optionally the optical interconnects on the bottom surface of wafer 314.

The method then comprises optionally attaching 412 the bottom surface of optional amplifier wafer 364 to the top surface of wafer 314, such that the output of each amplifier 368 of amplifier wafer 364 is electrically coupled to the output pads of a respective photodetector chip 320. The method further comprises attaching 414 the top surface of waveguide layer 342 to the bottom surface of wafer 314 such that each photodetector 320 of wafer 314 receives in input light from a waveguide 348 of wafer 342. Finally, the method comprises attaching 416 antenna wafer 330 to the top surface of wafer 314, optionally of wafer 364, such that each antenna patch 336 can emit a RF signal, optionally an amplified RF signal, converted into RF by a respective photodetector 320 of wafer 314 out of light received from a respective waveguide 348; and attaching optic fiber connectors 354 and eventually optic fibers to the bottom surface of layer 342 to receive light into the waveguides 348.

Optionally, the method comprises connecting 418 the connectors 354 or optic fibers coupled to the connectors to remote optoelectronics provided for generating the light input into the waveguides 348.

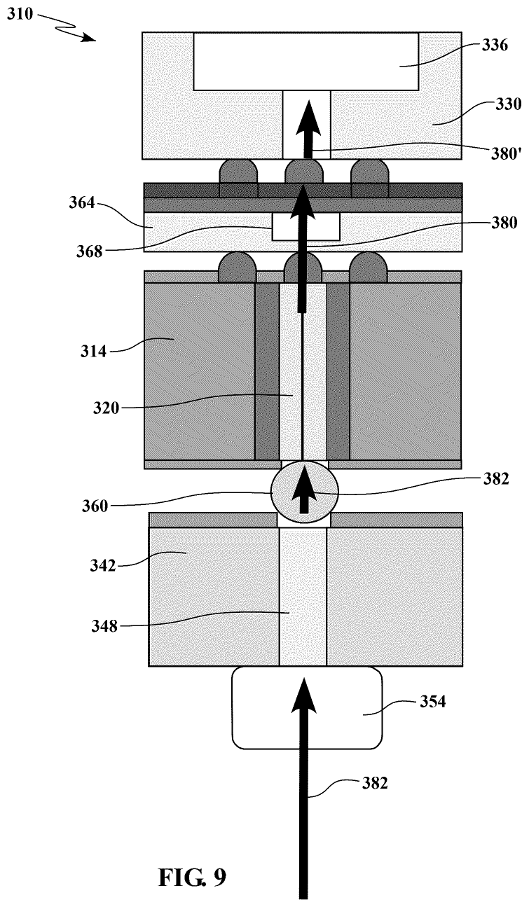

FIG. 9 illustrates a detail of an optoelectronic emitter 310 according to embodiments of this presentation, having a photodetector chip 320 in light detection wafer 314, associated to an antenna 336 in an antenna layer 330 attached on top of the light detection wafer 314. Optionally, a amplifier wafer 364 is sandwiched between the antenna wafer 330 and the light detection wafer 314, such that a RF modulated electrical signal 380 emitted by chip 320 is amplified into an electrical signal 380′ by an amplifier 368 in wafer 364 before being sent to antenna patch 336 for radio emission. An optical waveguide wafer 342 is attached to the bottom of light detector 314 and comprises a waveguide 348 arranged to couple a RF modulated light 382 into an optical input of photodetector chip 320 such that light 382 be converted into signal 380 by the photodetector 320. A lens 360 can be provided between the waveguide 348 and the photodetector 320 to better couple light 382 into photodetector 320. Light 382 can be introduced into waveguide 348 by a fiber optic connector 354.

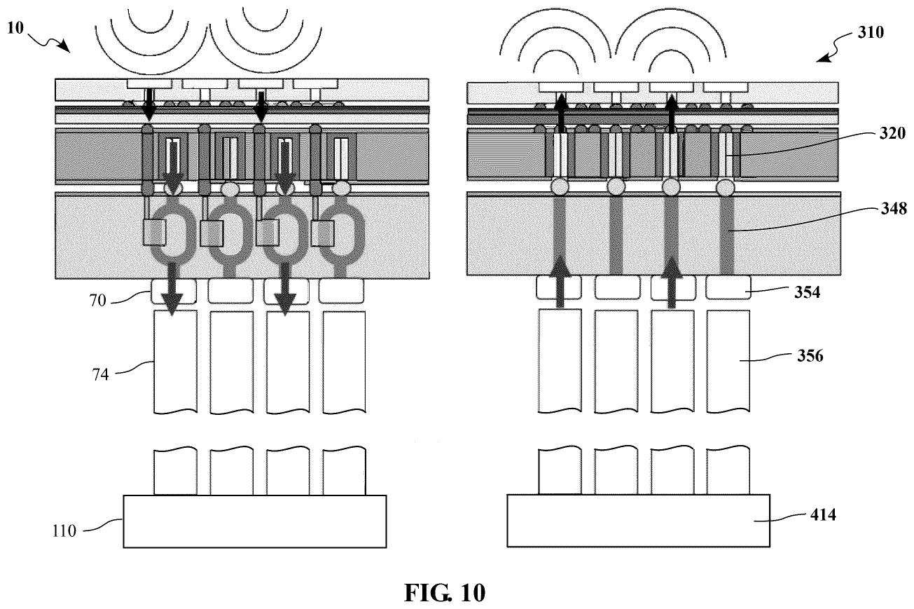

FIG. 10 illustrates a RF transceiver according to embodiments of this presentation, comprising an emitter phased array 310 such as illustrated in FIG. 6 and a receiver phased array 10 such as illustrated in FIG. 1. Each photodetector chip 320 of emitter phased array 310 is coupled by an optical waveguide 348 to an optic fiber connector 354 receiving a distal end of an optical fiber 356. A proximal end of optical fiber 356 is connected to a circuit 414 that can comprise circuits that can be bulky and/or generate heat, including a beamformer IC, ADC circuitry, logic, memory, etc. . . . . As outlined above, embodiments of this presentation allow for the leveraging of low-loss (nearly zero loss) fiber connections between individual elements in the 3D stack. In other words, the 3D stack can be split up into emitter 310 and receiver 10 on one hand and their control circuitry 414, 110 on the other hand, without added signal loss from separating out the layers due to the use of optical fibers 356, 74. As outlined above, embodiments have been described in relation to phased arrays provided to emit/receive RF signals but embodiments of this presentation can be scaled to even higher frequency bands.

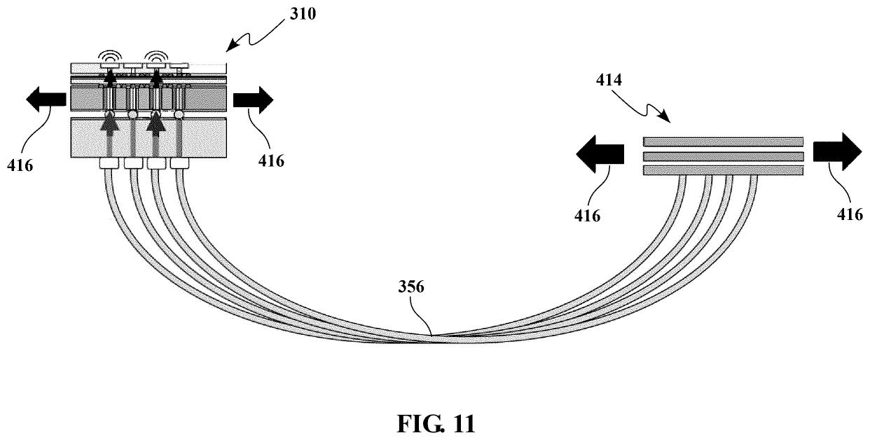

FIG. 11 illustrates an emitter phased array 310 as illustrated in FIG. 6 coupled to its control module 414 by optical fibers 356 as outlined in FIG. 10. FIG. 11 illustrates the heat 416 emitted by emitter 310 and circuit 414. Advantageously, arranging phased array 310 away from its control circuit 414 allows better thermal control of the combination.

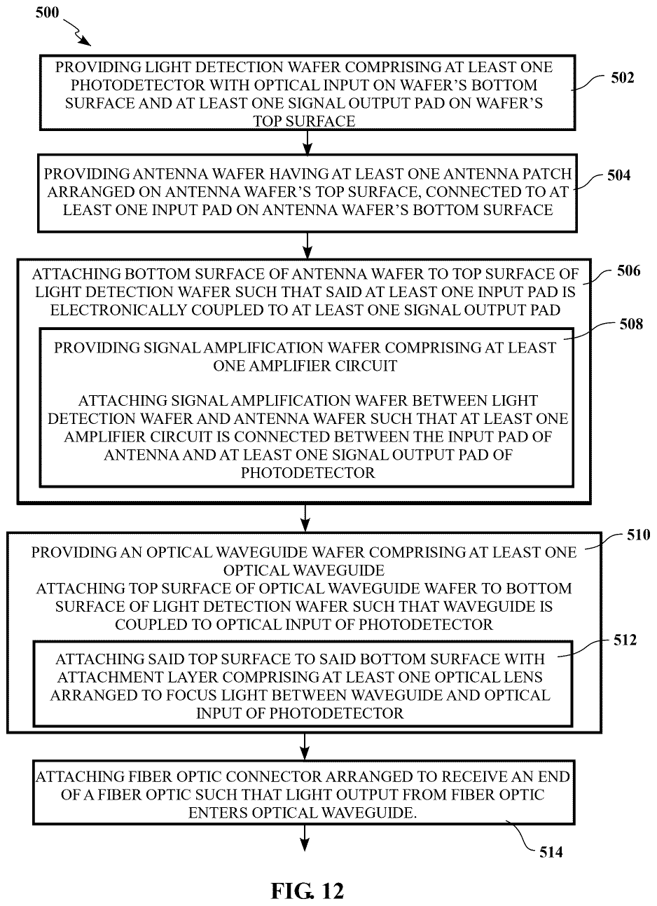

FIG. 12 illustrates a method 500 of fabricating an optoelectronic emitter according to embodiments of this presentation. Method 500 comprises providing 502 light detection wafer 314, comprising at least one photodetector chip 320 with optical input 324 on wafer's bottom surface 318 and a least one signal output pad 328 on wafer's top surface 316.

Method 500 further comprises providing 504 antenna wafer 330 having at least one antenna patch 336 arranged on antenna wafer's top surface 334, connected to at least one input pad 340 on antenna wafer's bottom surface 332.

Method 500 further comprises attaching 506 bottom surface 332 of antenna wafer 330 to top surface 316 of light detection wafer 314 such that said at least one input pad 340 is electrically coupled to at least one signal output pad 328.

Optionally, said attaching 506 bottom surface 332 to top surface 316 comprises 508 providing signal amplification wafer 364 comprising at least one amplifier circuit 368, and attaching signal amplification wafer 364 between light detection wafer 314 and antenna wafer 330 such that the at least one amplifier circuit 368 is connected between the input pad 340 of antenna patch 336 and the at least one signal output pad 328 of photodetector chip 320.

According to embodiments of this presentation, method 500 further comprises providing 510 an optical waveguide wafer 342 comprising at least one optical waveguide 348; and attaching a top surface 344 of optical waveguide wafer 342 to bottom surface 318 of light detection wafer 314 such that optical waveguide 348 is coupled to optical input 324 of photodetector chip 320.

Optionally, said attaching top surface 344 to bottom surface 318 includes attaching 512 top surface 344 to bottom surface 318 with an attachment layer 358 comprising at least one optical lens 360 arranged to focus light between waveguide 348 and optical input 324. Optionally, the method further comprises attaching 514 at least one fiber optic connector 354 arranged to receive an end of a fiber optic 356 such that light output from the fiber optic 356 enters the at least one optical waveguide 348.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112(f), sixth paragraph, unless the element is expressly recited using the phrase “means for . . . ” and no method or process step herein is to be construed under those provisions unless the step, or steps, are expressly recited using the phrase “comprising the step (s) of . . . . ”

All elements, parts and steps described herein are preferably included. It is to be understood that any of these elements, parts and steps may be replaced by other elements, parts and steps or deleted altogether as will be obvious to those skilled in the art.

What is claimed is:

1. An optoelectronic emitter comprising:
a light detection wafer having first top and bottom surfaces, the light detection wafer comprising at least one photodetector chip arranged to receive light in an optical input on the first bottom surface, along a photodetector axis normal to the first bottom surface and to output an electrical signal from at least one signal output pad on the first top surface; and
an antenna wafer having a second bottom surface attached to the first top surface and having a second top surface, at least one antenna patch being arranged on the second top surface and being connected by a via to a bottom antenna pad on the second bottom surface, the bottom antenna pad being electrically coupled to the at least one signal output pad on the first top surface.

2. The optoelectronic emitter of claim 1, comprising an optical waveguide wafer having a third top surface attached to the first bottom surface and having a third bottom surface; the optical waveguide wafer comprising at least one optical waveguide having a waveguide output on the third top surface and a waveguide input on the third bottom surface, the waveguide output being aligned with the photodetector axis; and a fiber optic connector arranged to receive an end of a fiber optic being attached to the third bottom surface such that light output from said fiber optic enters the optical waveguide by the waveguide input.

3. The optoelectronic emitter of claim 2, wherein the third top surface is attached to the first bottom surface by an attachment layer comprising at least one optical lens arranged to focus light output from the waveguide output on the third top surface into the optical input on the first bottom surface.

4. The optoelectronic emitter of claim 1, wherein the second bottom surface is attached to the first top surface by attaching the second bottom surface to a fourth top surface of a signal amplification wafer and attaching a fourth bottom surface of said signal amplification wafer to the first top surface; the signal amplification wafer comprising at least one amplifier circuit connected between the bottom antenna pad and the signal output pad on the first top surface.

5. The optoelectronic emitter of claim 2, wherein the antenna patch is provided for emitting a predetermined wavelength and has half-wavelength dimensions, wherein the at least one photodetector chip connected to the antenna patch and the at least one optical waveguide coupled to the at least one photodetector chip are located within a parallelepipedic region having lateral sides parallel to the photodetector axis and having a top side with half-wavelength dimensions.

6. The optoelectronic emitter of claim 5, wherein said predetermined wavelength is in the RF band.

7. The optoelectronic emitter of claim 3, comprising a fiber optic having a distal end received in said fiber optic connector and a proximal end coupled to an electrical to optical converter.

8. The optoelectronic emitter of claim 1, wherein the light detection wafer comprises a through-wafer cavity, and wherein the at least one photodetector chip is attached to at least one wall of the cavity by direct contact with a metal that fills the cavity.

9. The optoelectronic emitter of claim 1, wherein:
said at least one photodetector chip comprises a plurality of photodetector chips arranged each to receive light from a different one of a plurality of optical inputs on the first bottom surface and having each at least one signal output pad on the first top surface; and
said at least one antenna patch comprises a plurality of antenna patches connected each by a via to a different one of a plurality of bottom antenna pads coupled each to the at least one signal output pad of a different one of said plurality of photodetector chips.

10. The optoelectronic emitter of claim 9, comprising an optical waveguide wafer having a third top surface attached to the first bottom surface and having a third bottom surface; the optical waveguide wafer comprising a plurality of optical waveguides having each a waveguide output on the third top surface and a waveguide input on the third bottom surface, each one of the plurality of optical waveguides having its waveguide output being aligned with the photodetector axis of a different one of the plurality of photodetector chips; a plurality of fiber optic connectors arranged each to receive an end of a different fiber optic being attached to the third bottom surface such that light output from each of said different fiber optics enters one of the plurality of optical waveguides by its waveguide input.

11. The optoelectronic emitter of claim 10, wherein each antenna patch is provided for emitting a predetermined wavelength and has half-wavelength dimensions for said different predetermined wavelength, wherein the at least one photodetector chip connected to each antenna patch is located within a parallelepipedic region having lateral sides parallel to the photodetector axis and having a top side with the same half-wavelength dimensions as the antenna patch.

12. A method of manufacturing an optoelectronic emitter, the method comprising:
providing a light detection wafer having first top and bottom surfaces, the light detection wafer comprising at least one photodetector chip arranged to receive light in an optical input on the first bottom surface, along a photodetector axis normal to the first bottom surface and to output an electrical signal from at least one signal output pad on the first top surface;
providing an antenna wafer having a second bottom surface and having a second top surface, at least one antenna patch being arranged on the second top surface and being connected by at least one via to at least one bottom antenna pad on the second bottom surface; and
attaching the second bottom surface to the first top surface such that said at least one bottom antenna pad is electrically coupled to the at least one signal output pad on the first top surface.

13. The method of claim 12, further comprising providing an optical waveguide wafer having a third top surface and a third bottom surface; the optical waveguide wafer comprising at least one optical waveguide having a waveguide output on the third top surface and a waveguide input on the third bottom surface;
attaching the third top surface to the first bottom surface such that the waveguide output is aligned with the photodetector axis; and
attaching to the third bottom surface a fiber optic connector arranged to receive an end of a fiber optic such that light output from said fiber optic enters the optical waveguide by the waveguide input.

14. The method of claim 13, comprising attaching the third top surface to the first bottom surface with an attachment layer comprising at least one optical lens arranged to focus light from the waveguide output on the third top surface into the optical input on the first bottom surface.

15. The method of claim 12, comprising:
providing a signal amplification wafer having a fourth top surface and a fourth bottom surface and comprising at least one amplifier circuit; and
attaching the second bottom surface to the first top surface by attaching the second bottom surface to the fourth top surface and attaching the fourth bottom surface to the first top surface such that the at least one amplifier circuit is connected between the bottom antenna pad and the signal output pad on the first top surface.

16. The method of claim 13, wherein the antenna patch is provided for emitting a predetermined wavelength and has half-wavelength dimensions, wherein the at least one photodetector chip connected to the antenna patch and the at least one optical waveguide coupled to the at least one photodetector chip are located within a parallelepipedic region having lateral sides parallel to the photodetector axis and having a top side with half-wavelength dimensions.

17. The method of claim 12, wherein the light detection wafer comprises a through-wafer cavity, and wherein the at least one photodetector chip is attached to at least one wall of the cavity by direct contact with a metal that fills the cavity.

18. The method of claim 12, wherein:
said at least one photodetector chip comprises a plurality of photodetector chips arranged each to receive light from a different one of a plurality of optical inputs on the first bottom surface and having each at least one signal output pad on the first top surface; and
said at least one antenna patch comprises a plurality of antenna patches connected each by a via to a different one of a plurality of bottom antenna pads coupled each to the at least one signal output pad of a different one of said plurality of photodetector chips.

19. The method of claim 18, comprising providing an optical waveguide wafer having a third top surface and a third bottom surface; the optical waveguide wafer comprising a plurality of optical waveguides having each a waveguide output on the third top surface and a waveguide input on the third bottom surface;
attaching the third top surface to the first bottom surface such that each one of the plurality of optical waveguides has its waveguide output aligned with the photodetector axis of a different one of the plurality of photodetector chips;
providing a plurality of fiber optic connectors arranged each to receive an end of a different fiber optic; and
attaching each of said plurality of fiber optic connectors to the third bottom surface such that light output from each of said different fiber optics enters one of the plurality of optical waveguides by its waveguide input.

20. The method of claim 12, wherein each antenna patch is provided for emitting a predetermined wavelength and has half-wavelength dimensions for said different predetermined wavelength, wherein the at least one photodetector chip connected to each antenna patch is located within a parallelepipedic region having lateral sides parallel to the photodetector axis and having a top side with the same half-wavelength dimensions as the antenna patch.
